(19) United States
(12) Patent Application Publication
(10) Pub. No.: US 2025/0338364 A1
(43) Pub. Date: Oct. 30, 2025

(54) Invisacook Invisible Induction Cooktop System

(71) Applicant: Curtis Ceballos, Palm Coast, FL (US)

(72) Inventor: Curtis Ceballos, Palm Coast, FL (US)

(21) Appl. No.: 18/648,626

(22) Filed: Apr. 29, 2024

(51) Int. Cl. H05B 6/12; F24C 15/00; F24C 15/30; H05B 6/06; H05B 6/42

(52) U.S. Cl. CPC H05B 6/1209; F24C 15/006; F24C 15/30; H05B 6/062; H05B 6/42

(57) ABSTRACT

An induction cooktop system includes a casing defining a chamber, and at least one induction unit arranged inside the chamber. The at least one induction unit includes at least one induction coil to generate alternating magnetic field, a fan to draw air inside the casing to cool the at least one induction coil, and a pair of temperature sensors to monitor a temperature and arranged on the at least one induction coil. The induction cooktop system also includes a control panel to facilitate a user to control the at least one induction unit. The control panel includes at least one indicator to indicate a location of the at least one induction coil arranged underneath a stone. The induction cooktop system is adapted to be arranged underneath the stone countertop to heat an induction utensil arranged on the stone.

### TECHNICAL FIELD

The present disclosure relates, generally, to an induction cooktop system, and more particularly relates to an induction cooktop system having one or more induction cooking units arranged underneath a stone.

### SUMMARY

In one aspect of the disclosure, an induction cooktop system is disclosed. The induction cooktop system is adapted to be arranged underneath a stone countertop to heat an induction utensil arranged on the stone. The induction cooktop system includes a casing defining a chamber, and at least one induction unit arranged inside the chamber. The at least one induction unit includes at least one induction coil to generate alternating magnetic field, a fan to draw air inside the casing to cool the at least one induction coil, and a pair of temperature sensors to monitor a temperature and arranged on the at least one induction coil. The induction cooktop system also includes a control panel to facilitate a user to control the at least one induction unit. The control panel includes at least one indicator to indicate a location of the at least one induction coil arranged underneath the stone.

In some additional, alternative, or selectively cumulative embodiments, the at least one induction unit includes a housing having a bottom and defining at least one opening and the fan is arranged inside the housing and proximate to the at least one opening to draw air inside the housing through the at least one opening.

In some additional, alternative, or selectively cumulative embodiments, the at least one induction unit includes a circuit board connected to the at least one induction coil to control the at least one induction coil, wherein the fan draws air to cool the circuit board.

In some additional, alternative, or selectively cumulative embodiments, the circuit board is configured to shut-off the at least one induction coil in response to a determination of a rate of increase of the temperature of the stone being above a threshold value, wherein the rate of increase of the temperature is determined based on input from the pair of temperature sensors.

In some additional, alternative, or selectively cumulative embodiments, the at least one indicator includes at least one light emitting diode.

In some additional, alternative, or selectively cumulative embodiments, the control panel includes a ceramic glass panel.

In some additional, alternative, or selectively cumulative embodiments, the induction cooktop system further comprises a plurality of posts extending in a vertical direction from a base of the casing with a plurality of springs surrounding the plurality of posts, wherein the plurality of posts and the plurality of springs act as self-leveler for leveling the stone arranged supported on the casing.

In some additional, alternative, or selectively cumulative embodiments, the casing defines at least one hole to draw cooling air inside the casing.

### BRIEF DESCRIPTION OF THE DRAWINGS

FIG. 1 shows an exploded view of an induction cooktop system having three induction coils, in accordance with an embodiment of the present disclosure;

FIG. 2 shows an exploded view of an induction cooktop system having two induction coils, in accordance with an embodiment of the present disclosure;

FIG. 3 shows an exploded view of an induction cooktop system having five induction coils, in accordance with an embodiment of the present disclosure;

FIG. 4 shows an exploded view of an induction cooktop system having four induction coils, in accordance with an embodiment of the present disclosure;

FIG. 5 shows an exploded view of an induction cooktop system having a single induction coil, in accordance with an embodiment of the present disclosure;

FIG. 6 shows a bottom perspective view of the induction cooktop system of FIG. 1 with a stone supported on a casing of the induction cooktop system, in accordance with an embodiment of the present disclosure; and

FIG. 7 shows a top perspective view of the induction cooktop system of FIG. 1 with the stone supported on the casing of the induction cooktop system and depicting an illuminated control panel, in accordance with an embodiment of the present disclosure.

### DETAILED DESCRIPTION

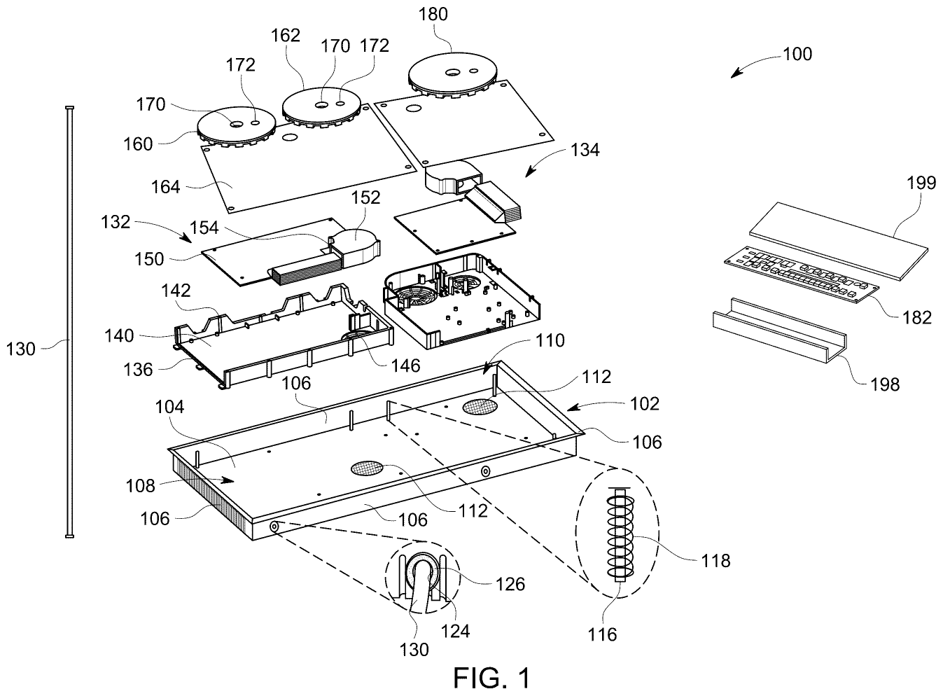

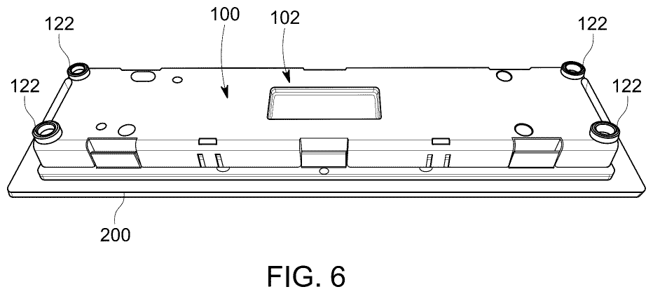

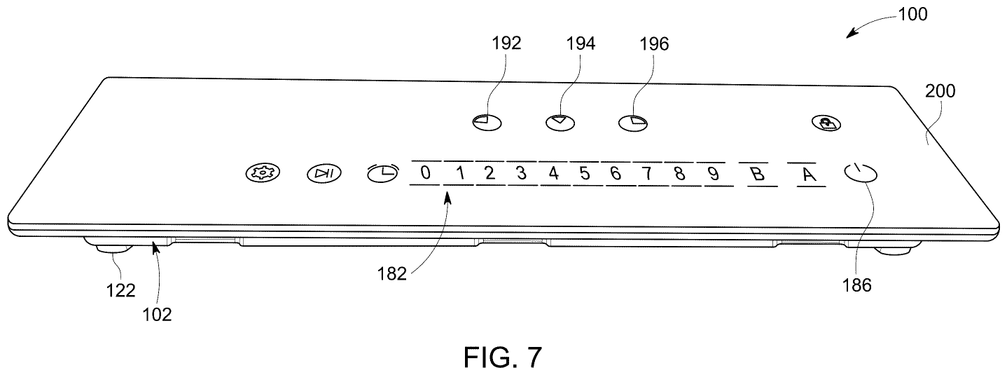

Referring to FIGS. 1, 6 and 7, an induction cooktop system 100 is shown, according to an example embodiment of the disclosure. As shown in FIGS. 6 and 7, the induction cooktop system 100 is arranged underneath a stone 200. Referring to FIG. 1, the induction cooktop system 100 includes a casing 102 having a base 104 and four walls 106 extending vertically from the base 104 and defining a chamber 108 therebetween to support and house various components of the system. As shown, the casing 102 is open from top defining a defining a top opening 110 which is covered by the stone 200 (shown in FIGS. 6 and 7). The opening 110 allows mounting of the components arranged inside the casing as well as access the components arranged inside the chamber 108. The components arranged inside the casing 102 is covered by the stone 200 from top, as best shown in FIG. 7. Also, the base 104 defines a at least one hole 112 extending through a thickness of the base 104 to allow a flow of air between an ambient environment and the chamber. Also, a plurality of metal posts 116 having springs 118 disposed surrounding the metal posts 116 are arranged in a vertical orientation inside the chamber 108 and extending upwardly from the base 104. The metal posts 116 with springs 118 function as self-levelers during installation of the induction Cooktop System 100 underneath the stone 200 (shown in FIGS. 6 and 7). Further, as shown in FIG. 6, the casing 102 includes a plurality of legs 122 extending outwardly from base 104 and connected to the base 104 to enable a positioning of the system 100 on a surface. Further, at least one of the walls 106 of the casing 102 defines a slot 124 to receive a grommet 126 and enables an extension of a cable 130 inside the chamber 108 from an outside of the casing 102.

Moreover, referring back to FIG. 1, the system 100 includes at least one induction unit, for example, a first induction unit 132 and a second induction unit 134, arranged inside the chamber 108 and supported on the casing 102. As shown, the first induction unit 132 includes a bracket/housing 136 arranged inside the chamber 108 and having a bottom 140 and at least one wall 142 extending vertically from the bottom 140. As shown, the bottom 140 defines at least one opening 146 to facilitate entry of air inside the housing 136. Further, the first induction unit 132 includes a circuit board 150, and a fan 152 arranged inside the housing 136 and supported on the housing 136. It may be noted that the fan 152 is arranged at the location of the openings 146 to draw air inside the housing 136 through the openings 146 to cool the circuit board and other components of the first induction unit 132. To effectively direct the air towards the circuit board 150 and its components, the fan 152 may include an outlet port 154.

The circuit board 150 may include various electrical and electronic components that provides and control oscillating electric field/current at a desired frequency. In some embodiments, the electric and electronic components of the first induction unit 132 are arranged on the underside of the circuit board 150 i.e., between the bottom 140 and the circuit board 150. Further, as shown in FIG. 1, the first induction unit 132 includes at least one induction coil, for example, a first induction coil 160 and a second induction coil 162 arranged at suitable gap from the first induction coil 160 to allow a flow of air between the induction coils 160, 162 to efficiently cool the induction coils 160, 162.

In the embodiment, the induction coils 160, 162 are made of copper and are arranged on top side of the circuit board 150 and electrically connected to the circuit board 150. It may be noted that electrical and electronic components mounted to the circuit board 150 controls the oscillating current through the induction coils 160, 162 to produce an alternating/oscillating magnetic field that oscillates at a desired frequency. This alternating magnetic field causes generation of eddy currents, and thus heat the induction utensil placed on the stone 200 (best shown in FIG. 7) to facilitate a cooking of a food item. Accordingly, the induction coils 160, 162 define two cooking zones of the system 100. In the embodiment, first induction coil 160 includes a diameter of 210 millimeters (mm), while the second induction coil 162 includes a diameter of 180 mm.

Moreover, in the illustrated embodiment of FIG. 1, the first induction unit 132 includes a plate 164 that may be made of a metal, for example, aluminum, and arranged covering the housing 136 from top such that that the induction coils 160, 162 are supported on top of the plate 164, while the circuit board 150 and the fan 152 are arranged underneath the plate 164. Moreover, the walls 142 of the housing 136 include suitable recesses to direct the air from the fan 152 to the induction coils 160, 162 to efficiently cool the induction coils 160, 162. Furthermore, a pair of temperature sensors 170, 172 are attached to top of each of the induction coils 160, 162 to measure a temperature of the countertop material, for example, stone 200, best shown in FIG. 7. The temperature sensors 170, 172 are communicatively coupled to the circuit board 150 and configured to stop supply of electric current to the induction coils 160, 162 in response to an abrupt rise in the temperature of the countertop material or temperature and/or a rate of increase of temperature being above a threshold value. In some embodiments, the pair of temperature sensors 170, 172 are arranged proximate to a center of the associated induction coil 160, 162. In the embodiment, the distance between two sensors 170, 172 is maintained between 1 mm and 3 mm. In some embodiments, the distance between the two sensors 170, 172 is 2 mm. In some embodiments, the sensor 170, 172 are arranged symmetrically on the associated induction coil 160, 162. Also, the first induction unit 132 is sized and arranged inside the casing 102 such that the induction coils 160, 162 are arranged completely within the casing 102 and remains below and upper edge of the casing 102. The second induction unit 134 is similar to the first induction unit 132 except that the second induction unit 134 includes a single induction coil 180 instead of two induction coils.

The system 100 further includes a control panel 182 arranged to facilitate a user to control the induction coils 160, 162, 180. For controlling the induction coils 160, 162, 180, the control panel 182 includes a user interface having a start-stop switch 186, shown in FIG. 7, to switch on and switch off the system 100. Further, the control panel 182 includes at least one coil control switch, for example, a first coil control switch, a second coil control switch, and a third coil control switch to control the oscillation current provided to the first induction coil 160, the second induction coil 162, and the third induction coil 180, respectively. It may be appreciated that a number of coil control switch may depend upon a number of induction coils. Moreover, the control panel 182 includes at least one indicator to indicate a location of the at least one induction coil i.e., at least one cooking zone or heating zone. In the embodiment, shown in FIG. 7, the control panel 182 includes a first indicator 192 to indicate a location of the first induction coil 160 i.e., first cooking zone, a second indicator 194 to indicate a location of the second induction coil 162 i.e., a second cooking zone, and a third indicator 196 to indicate a location of the third induction coil 180 i.e., a third cooking zone. It may be appreciated that a number of the indicators may corresponds to a number of induction coils of the system 100. In some embodiments, each of the indicators 192, 194, 196, shown in FIG. 7, may include one or more light emitting diodes (LEDs). In some embodiments, the center of a cooking zone can only be determined when the associated induction coil is covered by a cooking utensil to obtain feedback on where the cooking utensil is located. In some embodiments, the stone 200 may be a solid stone, porcelain, granite, non-resin natural marble, or non-resin quartzite.

As shown in FIG. 1, the control panel 182 is housed in a box 198 and a transparent removable lid 199 arranged covering a top opening of the box 198. The lid 199 may be a glass ceramic lid and the cooking zones are indicated on the glass. In some embodiments, control panel 182 may be an LED ceramic glass panel. Moreover, the control panel 182 may be a TFT (thin film transistor panel) adapted to facilitate a touch based control. To connect the control panel 182 to the circuit board 150 of an induction unit, at least one cable extends from the control panel 182 to associated circuit board 150. In some embodiments, the control panel 182 may be arranged distally from the casing 102. In such a case, a distance between the casing 102 and the control panel 182 may be between 1 meter and 3 meters, and to connect the circuit boards 150 with the control panel 182 cables of suitable lengths are utilized.

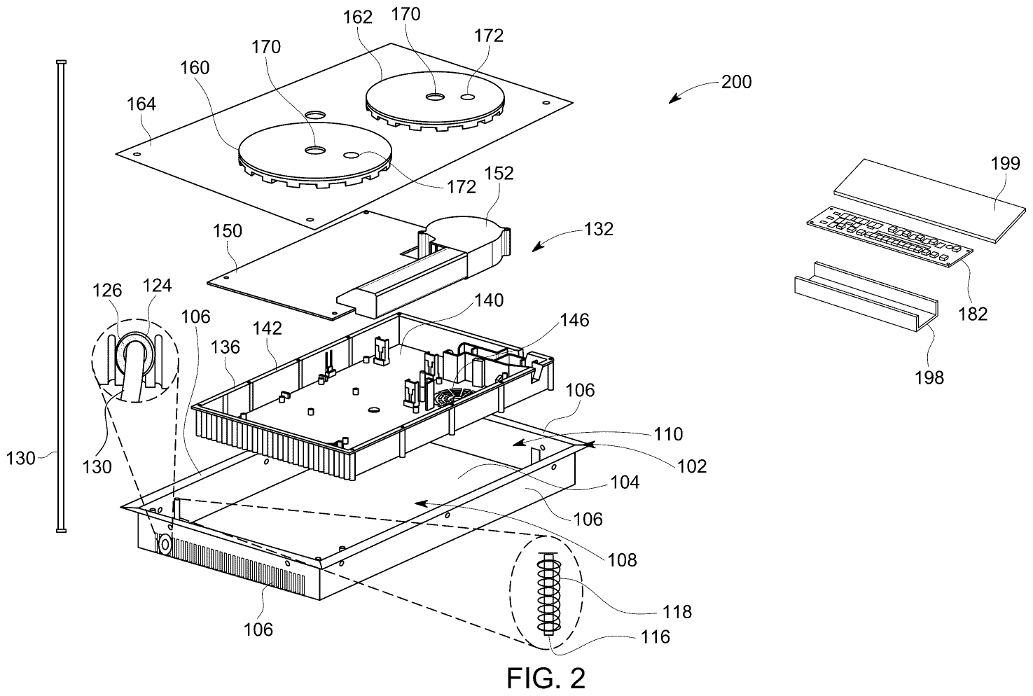

Referring to FIG. 2, an induction cooktop system 202 is shown. The induction cooktop system 202 is similar to the induction cooktop system 100 except that the second induction unit 134 is omitted from the induction cooktop system 202 and accordingly, the induction cooktop system 202 includes two induction coils 160, 162.

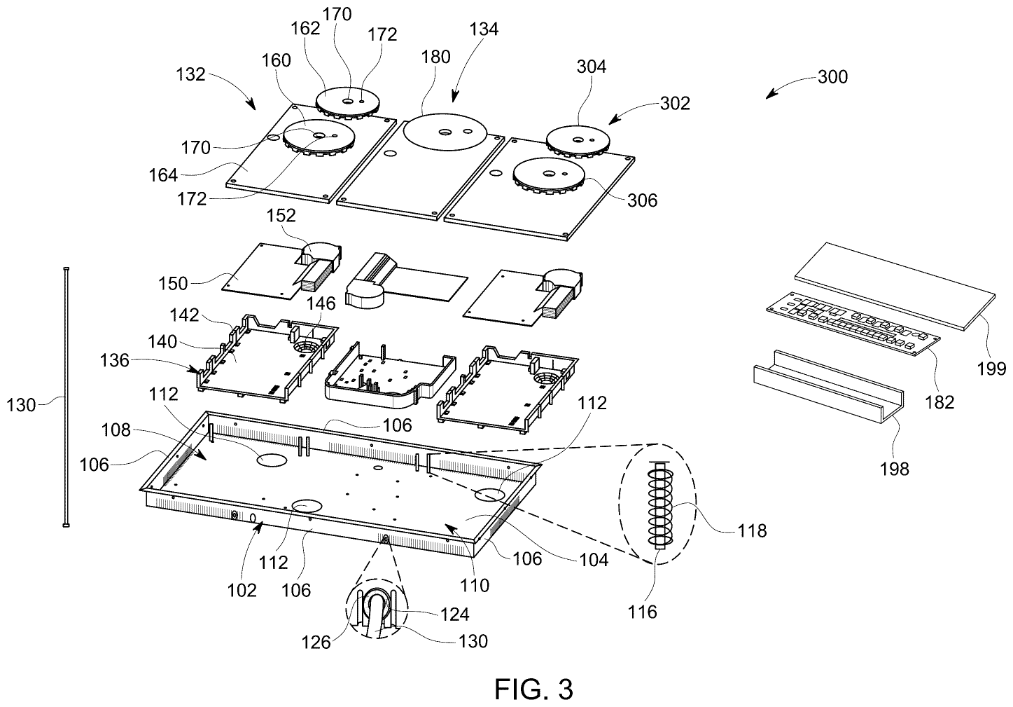

Referring to FIG. 3, an induction cooktop system 300 is shown. The induction cooktop system 300 is similar to the induction cooktop system 100 except that the induction cooktop system 300 includes a third induction unit 302 along with the first induction unit 132 and the second induction unit 134. The third induction unit 302 is similar to the first induction unit 132 and includes two induction coils 304, 306. Accordingly, the induction cooktop system 300, includes five induction coils.

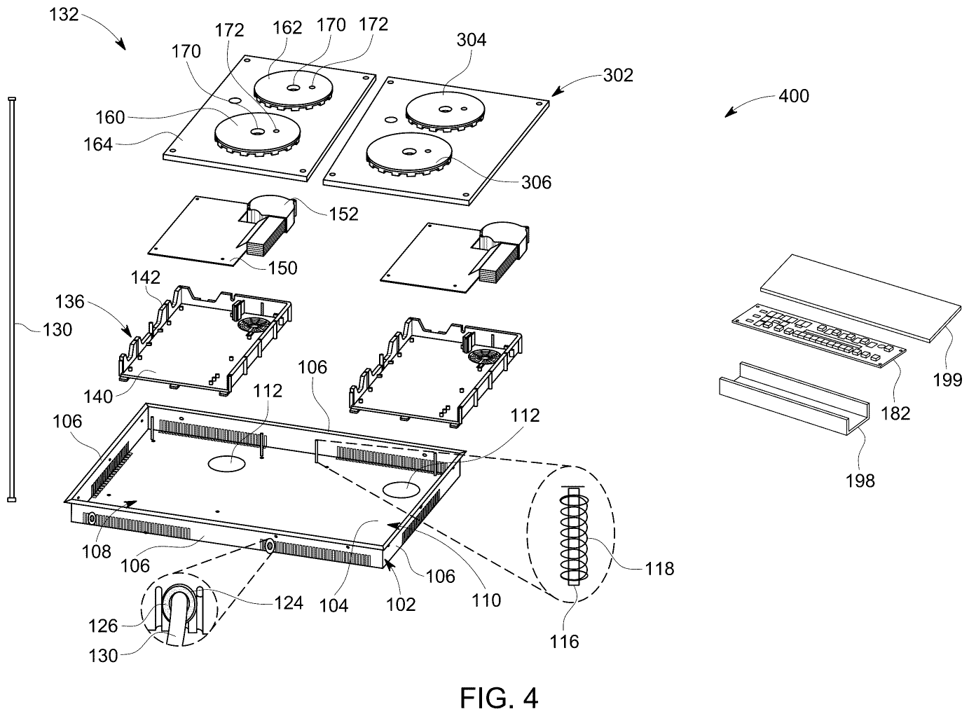

Referring to FIG. 4, an induction cooktop system 400 is shown. The induction cooktop system 400 is similar to the induction cooktop system 300 except that the induction cooktop system 400 includes the first induction unit 132 and the third induction unit 302, while the second induction unit 134 has been omitted. Accordingly, the induction cooktop system 400, includes four induction coils.

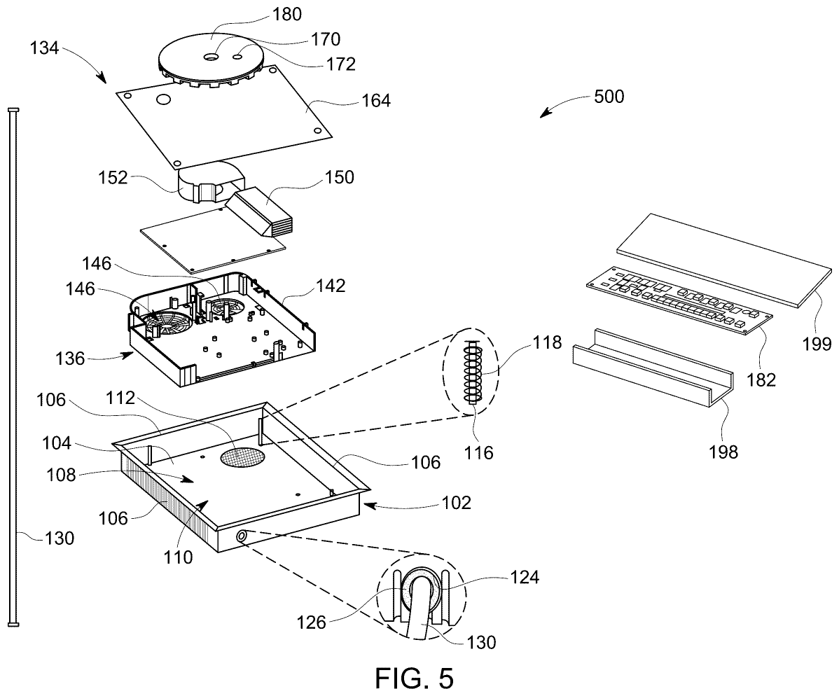

Referring to FIG. 5, an induction cooktop system 500 is shown. The induction cooktop system 500 is similar to the induction cooktop system 100 except that the induction cooktop system 500 includes the second induction unit 134 only having a single induction coil 180 and the first induction unit 132 is omitted from the induction cooktop system 500. Accordingly, the induction cooktop system 500 includes the third induction coil 180 only.

Like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

Many modifications and other implementations of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific implementations disclosed and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims.

### LIST OF REFERENCE NUMERALS

100 induction cooktop system
102 casing
104 base
106 wall
108 chamber
110 opening
112 hole
116 post
118 spring
122 leg
124 slot
126 grommet
130 cable
132 first induction unit
134 second induction unit
136 housing
140 bottom
142 wall
146 opening
150 circuit board
152 fan
154 outlet port
160 first induction coil
162 second induction coil
164 plate
170 temperature sensor
172 temperature sensor
180 third induction coil
182 control panel
186 start-stop switch
192 first indictor
194 second indicator
196 third indicator
198 box
199 lid
200 stone
202 induction cooktop system
300 induction cooktop system
302 third induction unit
304 induction coil
306 induction coil
400 induction cooktop system
500 induction cooktop system

What is claimed is:

1. An induction cooktop system adapted to be arranged underneath a stone countertop to heat an induction utensil arranged on the stone, the induction cooktop system comprising:
a casing defining a chamber;
at least one induction unit arranged inside the chamber and including
at least one induction coil to generate alternating magnetic field,
a fan to draw air inside the casing to cool the at least one induction coil,
a pair of temperature sensors to monitor a temperature and arranged on the at least one induction coil; and
a control panel to facilitate a user to control the at least one induction unit and including at least one indicator to indicate a location of the at least one induction coil arranged underneath the stone.

2. The induction cooktop system of claim 1, wherein the at least one induction unit includes a housing having a bottom and defining at least one opening and the fan is arranged inside the housing and proximate to the at least one opening to draw air inside the housing through the at least one opening.

3. The induction cooktop system of claim 2, wherein the at least one induction unit includes a circuit board connected to the at least one induction coil to control the at least one induction coil, wherein the fan draws air to cool the circuit board.

4. The induction cooktop system of claim 1, wherein the circuit board is configured to shut-off the at least one induction coil in response to a determination of a rate of increase of the temperature of the stone being above a threshold value, wherein the rate of increase of the temperature is determined based on input from the pair of temperature sensors.

5. The induction cooktop system of claim 1, wherein the at least one indicator includes at least one light emitting diode.

6. The induction cooktop system of claim 1, wherein the control panel includes a ceramic glass panel.

7. The induction cooktop system of claim 1 further comprises a plurality of posts extending in a vertical direction from a base of the casing with a plurality of springs surrounding the plurality of posts, wherein the plurality of posts and the plurality of springs act as self-leveler for leveling the stone arranged supported on the casing.

8. The induction cooktop system of claim 1, wherein the casing defines at least one hole to draw cooling air inside the casing.
